(19) United States
(12) Patent Application Publication
(10) Pub. No.: US 2025/0329262 A1
(43) Pub. Date: Oct. 23, 2025

(54) SYSTEM AND METHOD FOR TECHNICAL AND BEHAVIORAL COMPETENCY ASSESSMENT AND TRAINING MANAGEMENT

(71) Applicants: RISEN HR LLC, NAPERVILLE, IL (US); RISEN HR CONSULTANCY PVT LTD, CHENNAI (IN)

(72) Inventors: Karthikeyan SRINIVASAN, Chennai (IN); Srinivasan NATARAJAN, Wylie, TX (US); Jyothi VARMA, Puducherry (PK); Mohamed BAHADUR, NAPERVILLE, IL (US)

(73) Assignee: RISEN HR LLC, NAPERVILLE, IL (US)

(21) Appl. No.: 18/858,783

(22) PCT Filed: Dec. 10, 2023
(86) PCT No.: PCT/IN2023/051155

§ 371 Date: Oct. 22, 2024

(30) Foreign Application Priority Data
Dec. 27, 2022 (IN) 202241076011

(51) Int. Cl. G09B 5/00; G06Q 10/0631

(52) U.S. Cl. CPC G09B 5/00; G06Q 10/063112

(57) ABSTRACT

The various embodiments of the present invention provide a system and method for end-to-end skill/competency assessment for both technical and behavioral skills, objectively and scientifically. The invention comprises a portable skill capture device for capturing the technical and behavioral skills of a person. The skill capture device is configured to capture audio visual inputs enabling audio, image and video recording enabling evidence-based skill assessment and eliminating human bias. The invention also enables end-to-end training management including training needs assessment, training planning, administering training and training evaluation. The system is also configured to enable a plurality of operational aspects of training and assessments, including test paper authoring, test administration, data collection, data analysis, training needs assessment, training planning and administration, continuous assessment, dashboard generation and Management Information System (MIS) for further decision making.

### CROSS-REFERENCE TO RELATED APPLICATIONS

This patent application claims the priority of the Indian Provisional Patent Application filed on 27 Dec. 2022, with the number 202241076011 and titled, “SYSTEM AND METHOD FOR TECHNICAL AND BEHAVIORAL COMPETENCY ASSESSMENT AND TRAINING MANAGEMENT”, the contents of which are incorporated herein by the way of reference.

### TECHNICAL FIELD

The present invention is generally related to a system and method for competency assessment and training management. The present invention is particularly related to a system and method for an objective assessment of technical and behavioral competency of employees in an organization, and providing a customized training management for re-skilling, up-skilling and/or multi-skilling of employees in an organization.

### BACKGROUND ART

Training and assessment of skills of employees are integral part of various organizations. Various methods are followed by different organizations for skill assessment and training.

Some organizations use test papers, prepared by internal or external experts, for skill assessment. The test papers are administered to the target population (employees in the organization) to be assessed for a set of desired technical or behavioral competencies and for further training. However, the test papers may not cover all the required knowledge domains, as it is mainly dependent on the competency levels, and the time available by the individual(s) setting the question papers. The varying levels of knowledge, interest, and effort put-in by the test creators affect the quality of the test papers and the assessment. The results or reports of tests carried out in such a manner may be inadequate to base a judgment on the skill levels of the target population and the assessment of the training requirements may lack adequacy and accuracy. Additionally, in most cases, the test areas covered may not meet the global standards of assessment.

Some organizations prepare a list of desired areas or parameters and traits to be assessed in a target population and provide the same to the immediate supervisor(s) or peer(s) for inputs on a target candidate. The supervisor(s) or peer(s) provide their inputs indicating the level of technical/behavioral competencies present in the individual being assessed. However, the list of desired areas/parameters and the traits remain at a higher level and may not provide the specific parameters or sub-traits or particulars of measurement, thereby lacking depth and specificity. Further, the assessment methodology is subjective and hence, it may not be adequate for making a judgment on the skill levels of the target population. Training needs assessment based on such reports lacks evidence and the tests areas covered may not meet the global standards of assessment.

Some organizations use Learning Management Systems, which serves only as a repository of courses and learning materials for employees to take up post training needs assessments.

Hence, there exists a need for a system and method to carry out assessments smoothly, effectively, and scientifically. There also exists a need for a system and method to meet the end-to-end requirements, starting from test paper authoring, test administration, data collection, data analysis, training needs assessment, training planning and administration, continuous assessment, dashboard generation and Management Information System (MIS) for further decision making.

The abovementioned shortcomings, disadvantages and problems are addressed herein, which will be understood by reading and studying the following specification.

### OBJECT OF THE INVENTION

The primary object of the present invention is to provide a system and method for skill/competency assessment for both technical and behavioral skills, objectively and scientifically.

Another object of the present invention is to provide a portable device for capturing the technical/behavioral skills of a person.

Yet another object of the present invention is to provide a system and method for training management that includes training needs assessment, training planning, administering training and training assessment.

These and other objects and advantages of the present invention will become readily apparent from the following detailed description taken in conjunction with the accompanying drawings.

### SUMMARY OF INVENTION

The various embodiments of the present invention provide a system and method for end-to-end technical and behavioral competency assessment and training management. The embodiment also provides a system and a method for capturing the technical and behavioral skills of a person.

According to one embodiment of the present invention, a system is provided for end-to-end technical and behavioral competency assessment and training management. The system comprises a skill capture device, skill assessment dashboard, training delivery module, network interfaces and a back-end module that includes processing module, AI module, communications module, training management module, assessment module and database module.

According to one embodiment of the present invention, a system is provided for portable skill capture device for capturing the technical/behavioral skills of a person. The system comprises sensor module, computer input module, user authentication module, communications interface, storage module, memory module, processor, and output module.

According to one embodiment of the present invention, a method is provided for end-to-end technical and behavioral competency assessment and training management. The method comprises creating list of unique trades/duty positions, generating a skill directories bank, skill assessment, creating individual and department-wise skill assessment report, creating training plan based on assessment report, delivering the training, post training assessment, re-training/multi-skilling, creating management report and providing feedback for skill planning.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The other objects, features and advantages will occur to those skilled in the art from the following description of the preferred embodiment and the accompanying drawings in which:

FIG. 1 illustrates a system for end-to-end technical and behavioral competency assessment and training management, according to one embodiment of the present invention.

FIG. 2 illustrates a system for skill capture device for capturing the technical/behavioral skills of a person, according to one embodiment of the present invention.

FIG. 3 illustrates a method for end-to-end technical and behavioral competency assessment and training management, according to one embodiment of the present invention.

FIG. 4 illustrates a method for knowledge assessment process, according to one embodiment of the present invention.

FIG. 5 illustrates a method for practical skill assessment process, according to one embodiment of the present invention.

FIG. 6 illustrates a method for training management process, according to one embodiment of the present invention.

Although the specific features of the present invention are shown in some drawings and not in others. This is done for convenience only as each feature may be combined with any or all of the other features in accordance with the present invention.

### DESCRIPTION OF EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a system and method for end-to-end technical and behavioral competency assessment and training management. The embodiment also provides a system and a method for capturing the technical and behavioral skills of a person.

According to one embodiment of the present invention, a system is provided for end-to-end technical and behavioral competency assessment and training management. The system comprises a skill capture device, skill assessment dashboard, training delivery module, network interfaces and a back-end module that includes processing module, AI module, communications module, training module, assessment module and database module.

According to one embodiment of the present invention, a system is provided for portable skill capture device for capturing the technical/behavioral skills of a person. The system comprises sensor module, computer input module, user authentication module, communications interface, storage module, memory module, processor, and output module. The sensor module comprises a plurality of sensors, including imaging sensors, inertial sensors, proximity sensors, pressure sensors and haptic sensors. The computer input module comprises a plurality of input modules including keyboard, trackpad, mouse, microphone, external media readers and touch input. The communication interface is configured to support a plurality of communication protocols including WiFi, Bluetooth and Zigbee. The output module is configured to enable a plurality of output including audio-visual output, augmented reality (AR) and virtual reality (VR).

According to one embodiment of the present invention, a method is provided for end-to-end technical and behavioral competency assessment and training management. The method comprises creating list of unique trades/duty positions, generating a skill directories bank of technical and behavioral skills required for each trade/duty position, assessment of an individual's technical and behavioral skills, creating individual and department-wise skill assessment report, creating training plan based on assessment report, delivering the training, post training assessment, re-training/multi-skilling, creating management report and providing feedback for skill planning. The skill directories are configured for a plurality of skills comprising skills for process, maintenance and practical assessment including Safety, Emergency preparation, SIPOC, PPC, Major Machine Parts, Operating Panel/HMI, Specifications, SOP/Work instructions, Start-up checklist, Inspection, Defects, Waste loss management, Energy conservation and implementation of 5S in the workspace. The skill assessment report is configured to enable assessment of training needs, organizational intelligence, level of employee burn-out and happiness, and employee satisfaction.

According to one embodiment of the present invention, a method is provided for knowledge assessment process as per global standards. The method comprises creating a list of trades/duty positions, creating skill directories and question bank for each trade/duty position, technical/behavioral skill assessment, generating skill evaluation report and providing the evaluation report for assessment and skill planning.

According to one embodiment of the present invention, a method is provided for practical skill assessment process. The method comprises generating skill observation template for equipment and unique duty position as per global standards, individual's skill observation, recording performance and practical skills with evidence, generating skill evaluation report, providing skill evaluation report for assessment and skill planning.

According to one embodiment of the present invention, a method is provided for training management process. The method comprises creating training needs bank for technical and behavioral skills, creating training plan, creating training calendar, delivering the training and carrying out post training evaluation.

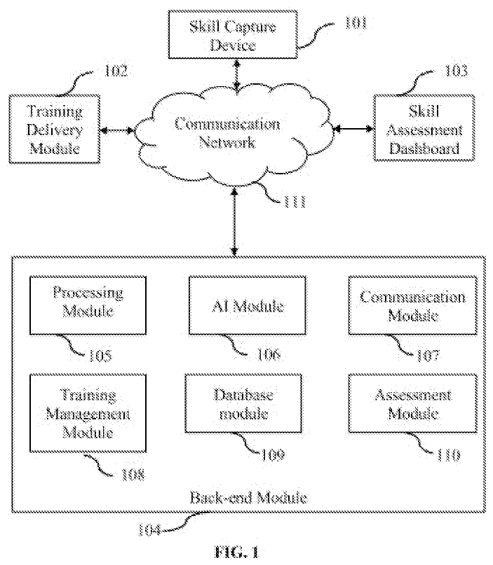

FIG. 1 illustrates a system for end-to-end technical and behavioral competency assessment and training management, according to one embodiment of the present invention. The system comprises skill capture device 101, training delivery module 102, skill assessment dashboard 103, back-end module 104 that further includes, processing module 105, Artificial Intelligence (AI) module 106, communications module 107, training management module 108, database module 109, assessment module 110, and a communication network 111.

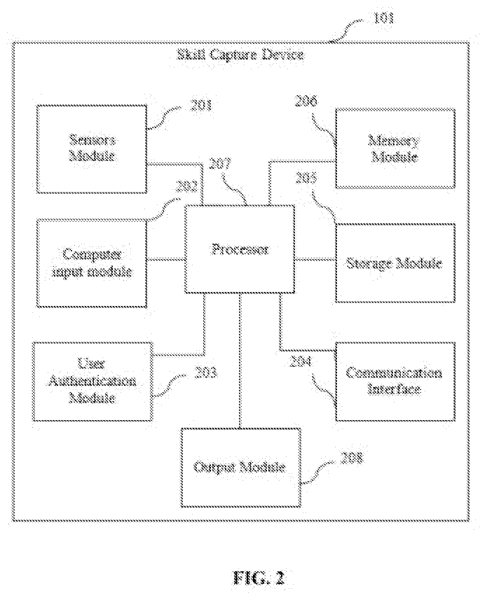

FIG. 2 illustrates a system for skill capture device for capturing the technical/behavioral skills of a person, according to one embodiment of the present invention. The system comprises a sensor module 201, computer input module 202, user authentication module 203, communications interface 204, storage module 205, memory module 206, processor 207, and output module 208.

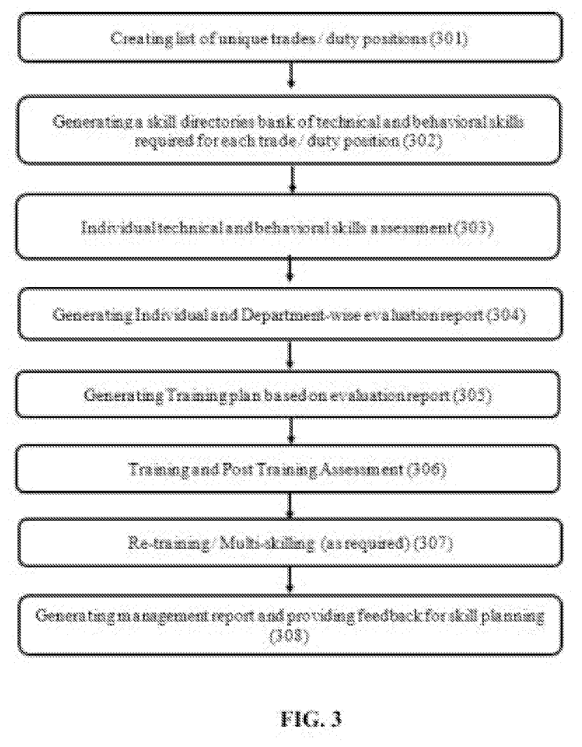

FIG. 3 illustrates a method for end-to-end technical and behavioral competency assessment and training management, according to one embodiment of the present invention. The method comprises: creating list of unique trades/duty positions (301); generating skill directories bank of technical and behavioral skills required for each trade/duty position (302); individual technical and behavioral skills assessment (303); generating individual and department-wise evaluation report (304); generating training plan based on assessment report (305); training and post Training Assessment (306); re-training/multi-skilling (as required) (307); and, generating management report and providing feedback for skill planning (308).

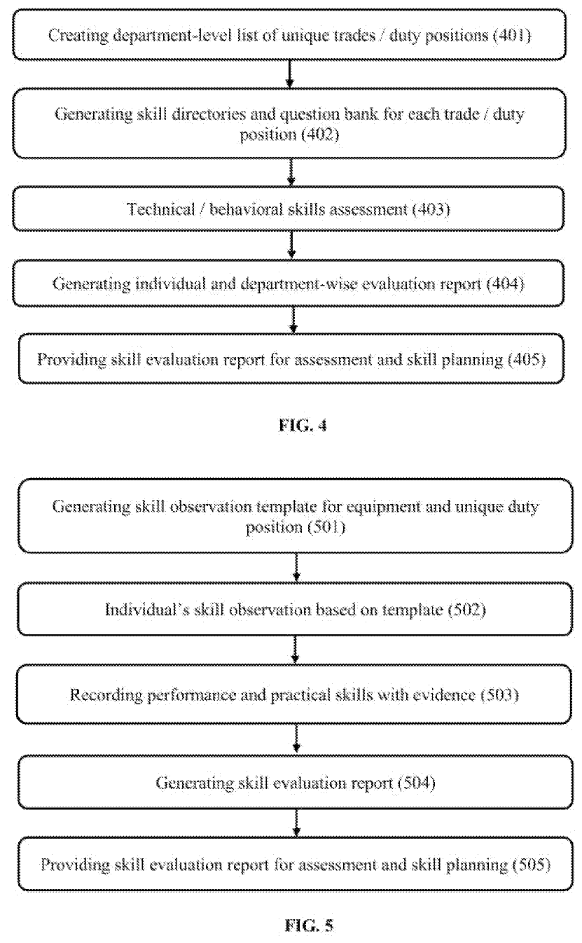

FIG. 4 illustrates a method for knowledge assessment process, according to one embodiment of the present invention. The method comprises: creating department-level list of unique trades/duty positions (401); generating skill directories and question bank for each trade/duty position (402); technical and behavioral assessment (403); generating individual and department-wise evaluation report (404); and, providing skill evaluation report for assessment and skill planning (405).

FIG. 5 illustrates a method for practical skill assessment process, according to one embodiment of the present invention. The method comprises: generating skill observation template for equipment and unique duty position (501); individual's skill observation based on template (502); recording performance and practical skills with evidence (503); generating skill evaluation report (504); and, providing skill evaluation report for assessment and skill planning (505).

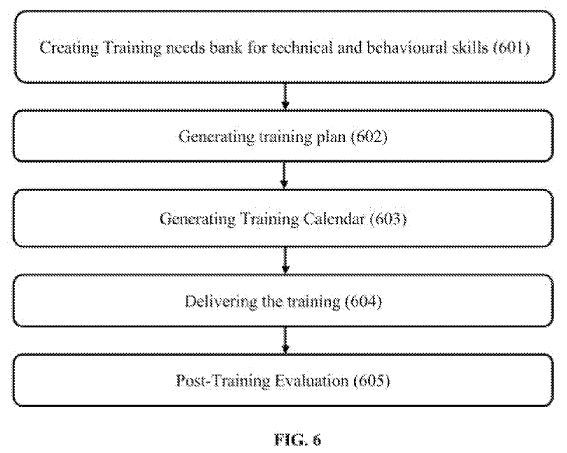

FIG. 6 illustrates a method for training management process, according to one embodiment of the present invention. The method comprises: creating training needs bank for technical and behavioral skills (601); generating training plan (602); generating training calendar (603); delivering the training (604); and, post-training evaluation (605).

Although the embodiments herein are described with various specific embodiments, it will be obvious for a person skilled in the art to practice the embodiments herein with modifications.

### ADVANTAGEOUS EFFECTS OF INVENTION

The various embodiments of the present invention provide a holistic framework, methodology and a platform to organizations to fulfil their goals on skill and competency assessment of entire workforce. The invention enables organizations to provide customized skill assessment and training based on specific requirements of each organization or department, thereby improving the effectiveness of the assessment and training. The method of skill assessment for knowledge and practical skills provides a comprehensive list of technical skills that meet world-class standards. The skill capture device is configured to pre-load skill assessment templates specific to a particular job/duty position that improves the time to commence the assessment and reduces the human errors in skill assessment. The skill capture device is also configured to capture audio visual inputs enabling audio, image and video recording enabling evidence-based skill assessment and eliminating human bias. The system for portable skill capture device enables carrying of the device to the workplace of individuals, for observing the practical skills required to do a job effectively.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A system for end-to-end technical and behavioral competency assessment and training management, the system comprising:
a skill capture device, wherein the skill capture device is configured to capture technical and behavioral skills of a person;
a skill assessment dashboard, wherein, the skill assessment dashboard is configured to receive and analyze data points and responses from the skill capture device, and providing a plurality of analyses for technical and behavioral skills;
a training delivery module, wherein the training delivery module is configured to assign specific training modules to users based on the analysis from the skill assessment dashboard, and wherein, the training delivery module is also configured to deliver training through digital means to remote and local user;
an Artificial Intelligence (AI) module; and,
a back-end module, wherein the back-end module further comprises a processing module, a communications module, a training management module, an assessment module, a database module, wherein the back-end module enables test paper authoring, test administration, data collection, data analysis, training needs assessment, training planning and administration, continuous assessment, dashboard generation, and Management Information System (MIS) for decision-making.

2. The system as claimed in claim 1, wherein the skill capture device is configured to capture audio-visual inputs, enabling audio, image, and video recording for evidence-based skill assessment and eliminating human bias, and wherein, the skill capture device is equipped with a sensor module that further includes imaging sensors, inertial sensors, proximity sensors, pressure sensors, and haptic sensors; a computer input module further comprising keyboard, trackpad, mouse, microphone, external media readers, and touch input; a user authentication module; a communications interface supporting a plurality of communication protocols including WiFi, Bluetooth, and Zigbee; a storage module; a memory module; a processor; and an output module enabling audio-visual output, augmented reality (AR), and virtual reality (VR).

3. The system as claimed in claim 1, wherein the AI module includes virtual avatars and virtual trainers configured to assess and guide users based on technical and behavioral skills, and wherein, the AI module is pre-configured with skill definitions linking trades and assessment modules, shortlisting candidates based on parameters and data generated, taking inputs from the skill capture device and triggering training delivery.

4. A method for end-to-end technical and behavioral competency assessment and training management, the method comprising:
creating a list of unique trades/duty positions;
generating skill directories bank of technical and behavioral skills required for each trade/duty position;
assessing individual technical and behavioral skills using the skill capture device;
generating individual and department-wise skill assessment report;
creating a training plan based on the assessment report;
delivering training modules;
conducting post-training assessments;
providing re-training/multi-skilling as required;
generating management reports and providing feedback for skill planning.

5. The method as claimed in claim 4, wherein the technical and behavioral skills are assessed based on evidence captured through audio, image, and video recording using the skill capture device, and wherein, the skill capture device further captures biometric feedback including facial cues, body language, actions, and gestures for assessing behavioral skills of the person.

6. The method as claimed in claim 4, wherein the AI module is configured to shortlist candidates for training based on technical and behavioral skill assessment data and triggers training delivery according to the decision it takes.

7. The method as claimed in claim 4, wherein the method further includes a knowledge assessment process, which further comprises: creating department-level list of unique trades/duty positions; generating skill directories and question bank for each trade/duty position; technical and behavioral assessment; generating individual and department-wise evaluation report; and, providing skill evaluation report for assessment and skill planning.

8. The method as claimed in claim 4, wherein the method further includes a practical skill assessment process, which further comprises: generating skill observation template for equipment and unique duty position; individual's skill observation based on template; recording performance and practical skills with evidence; generating skill evaluation report; and, providing skill evaluation report for assessment and skill planning.

9. The method as claimed in claim 4, wherein the method further includes a training management process, which further comprises: creating training needs bank for technical and behavioral skills; generating training plan; generating training calendar; delivering the training; and, post-training evaluation.
